(19) United States
(12) Patent Application Publication
(10) Pub. No.: US 2007/0098160 A1
(43) Pub. Date: May 3, 2007

(54) SCRAMBLING AND SELF-SYNCHRONIZING DESCRAMBLING METHODS FOR BINARY AND NON-BINARY DIGITAL SIGNALS NOT USING LFSRs

(76) Inventor: Peter Lablans, Morris Township, NJ (US)

Correspondence Address: DIEHL SERVILLA LLC, 77 BRANT AVE, SUITE 110, CLARK, NJ, 07066, US

(21) Appl. No.: 11/555,730

(22) Filed: Nov. 2, 2006

Related U.S. Application Data
(60) Provisional application No. 60/733,308, filed on Nov. 3, 2005.

(51) Int. Cl. H04L 9/00

(52) U.S. Cl. 380/46

(57) ABSTRACT

The invention discloses methods to create binary and n-valued sequences using addressable memory methods. Methods and apparatus to scramble and descramble binary and non-binary sequences using addressable memory methods are also disclosed. The invention further discloses methods using addressable memory to scramble binary and non-binary sequences and corresponding self-synchronizing descrambling methods with limited error propagation. Scrambling and descrambling methods for binary and non-binary methods are disclosed that can not or not easily be realized with LFSR based methods. Methods for dynamically changing functions in scramblers and descramblers are also disclosed.

### CROSS-REFERENCE TO RELATED APPLICATIONS

This application claims the benefit of U.S. Provisional Patent Application Ser. No. 60/733,308, filed Nov. 3, 2005, which is incorporated herein by reference.

### BACKGROUND OF THE INVENTION

This invention relates to the scrambling and descrambling of binary and non-binary digital sequences. More specifically it provides novel methods that cannot be realized by known LFSR based methods which apply shift registers with feedback.

Known LFSR based scramblers and descramblers may assumed to be derived from LFSR based sequence generators. An LFSR based sequence generator is a state machine (under control of a clock signal, but with no other external signal) wherein the output is determined by the state of the shift register. The output signal creates a new state of the shift register, which in turn creates a new output signal. These LFSR based shift register states are cyclic. After a certain number of different states a previously achieved state is reached and the cycle will repeat itself. An exception exists for a known forbidden state which will not change when achieved.

LFSR based scramblers have an external input signal that will affect the next state of the shift register. Each generated output signal moves at a clock pulse into the shift register. Eventually the state of the scrambler shift register reflects directly the output of the scrambler.

LFSR based methods for generating and scrambling binary sequences are widely used in applications such as telecommunications and data storage. LFSR based methods can also be used for generating and scrambling non-binary sequences. Sometimes the use of LFSR circuitry, specifically applying a shift register which requires unacceptable power levels, is not desirable or possible. In that case other methods that lead to the same results are required. Also the feedback functions in LFSRs are known and create highly predictable shift register states, which is not always desirable. Thus scrambling methods with a greater variety of shift register states are required.

### SUMMARY OF THE INVENTION

In view of the more limited possibilities of the prior art in scrambling binary and non-binary digital sequences by means of LFSR methods, the current invention provides additional methods and apparatus for the scrambling of digital sequences and self-synchronizing descrambling of the descrambled sequences.

The general purpose of the present invention, which will be described subsequently in greater detail, is to provide novel methods and apparatus which can be applied in the scrambling of binary and multi-valued digital sequences. In general the digital sequences that are scrambled may assumed to be unpredictable and may be comprised of any valid sequence of binary or n-valued symbols. This may include long series of identical symbols or repeating patterns of symbols. The individual symbols in a sequence may represent a signal. Signals are usually of an electrical or optical nature, but they may be of any valid distinguishable physical phenomenon.

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

Binary in the context of this application means 2-valued. Multi-valued and n-valued in the context of this invention means an integer greater than 2.

One object of the present invention is to provide new methods to generate a sequence of digital symbols.

Another object of the present invention is to create memory based scramblers that will scramble an incoming digital signal.

Another object is to descramble a descrambled digital signal by addressable memory methods in such a way that the original signal is recovered without mistakes.

Another object is to create self-synchronizing descramblers, wherein errors due to loss of synchronization or errors in the scrambled signal are affecting the descrambled signal in a limited way and do not catastrophically propagate through the remainder of the descrambled signal after occurrence of errors.

Another object of the present invention is to create non-LFSR, memory based methods to scramble and descramble binary and non-binary sequences which cannot be realized with only LFSRs.

### BRIEF DESCRIPTION OF THE DRAWINGS

Various other objects, features and attendant advantages of the present invention will become fully appreciated as the same becomes better understood when considered in conjunction with the accompanying drawings, and wherein:

FIG. 1 is a block diagram of an LFSR based sequence generator.

FIG. 2 is a diagram of a sequence generator in addressable memory configuration.

FIG. 3 is another diagram of an addressable memory based sequence generator.

FIG. 4 is a diagram of two consecutive memory lines.

FIG. 5 is a diagram of an LFSR based scrambler.

FIG. 6 is a diagram showing a number of consecutive states of an addressable memory based scrambler.

FIG. 7 is a diagram of an addressable memory based scrambler.

FIG. 8 is a diagram showing a number of consecutive states of an addressable memory based descrambler.

FIG. 9 is a diagram of an addressable memory based descrambler.

FIG. 10 is a diagram of a memory based scrambler wherein functions can be changed dynamically.

FIG. 11 is a diagram of a memory based descrambler wherein functions can be changed dynamically.

FIG. 12 is a diagram of a shift register based scrambler wherein functions can be changed dynamically.

### DETAILED DESCRIPTION OF THE INVENTION

The Related Art

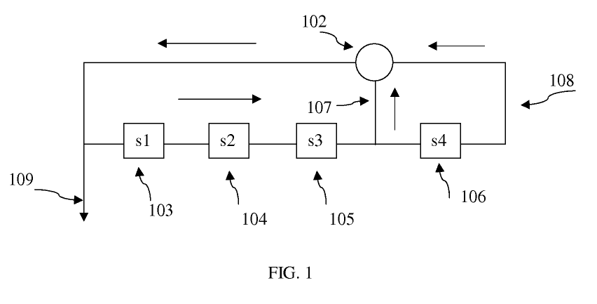

Binary scramblers, descramblers and sequence generators using Linear Feedback Shift Register (LFSR) methods are known. FIG. 1 shows a diagram of a binary LFSR based sequence generator. The generator comprises a 4-element shift register with 4 elements 103, 104, 105 and 106. It also has a binary device 102 that will execute a binary XOR function. The input signals to 102 are provided by the outputs 107 of shift register element 105 and output 108 of shift register element 106. The output of the device 102 is provided on 109, which is also the output of the generator. The shift register is controlled by a clock signal (which is not shown but is assumed). On each clock signal the contents of the register elements move one position to the right. The first element 103 assumes the value provided by the output 109. The diagram in FIG. 1 is provided as an illustrative example. There are many different configurations possible, including more or less shift register elements, more and other binary or non-binary devices, and different feedback taps. An analysis of this type of sequence generator and alternative approaches is provided by the inventor in U.S. Non-Provisional patent application Ser. No. 11/427,498 filed on Jun. 29, 2006 entitled CREATION AND DETECTION OF BINARY AND NON-BINARY PSEUDO-NOISE SEQUENCES NOT USING LFSR CIRCUITS which is incorporated herewith in its entirety by reference. In fact it is shown that the sequence generator, certainly if it generates a binary or non-binary sequence of maximum length can be characterized by a series of decimal numbers. Such a decimal sequence then has n^{p}−1 non-repeating numbers and each number consists of p n-valued digits. Each number is the decimal representation of a word of n-valued symbols. Each word is overlapped by its consecutive word.

Each LFSR based sequence generator has one forbidden state. The forbidden state of the LFSR in FIG. 1 is [0 0 0 0]. The inventor has shown that binary and non-binary LFSR based circuits can be realized by addressable memory or Look-up table type methods in U.S. Non-Provisional patent application Ser. No. 11/534,837 filed on Sep. 25, 2006 entitled: GENERATION AND SELF-SYNCHRONIZING DETECTION OF SEQUENCES USING ADDRESSABLE MEMORIES, which is hereby incorporated by reference herein in its entirety. The present invention differs from the inventions described in the cited patents in different aspects.

One important difference is that in the current invention no feedback functions are required. These functions will now be reflected in the states of an addressable memory.

One of the attractions of LFSR based scramblers and sequence generators is that sequences can be detected or descrambled by self-synchronizing LFSR methods and circuits. Transmitter and receiver of digital sequences are often in different location. Consequently the use of coding or scrambling methods often require some form of synchronization of the decoder in the receiver with the coder in the transmitter. LFSR based descramblers are self-synchronizing and do not require state synchronization to overcome line errors.

During descrambling it is possible to lose synchronization if for some reason an error occurs in the received signal or in the shift register. However after the receiving shift register is flushed from its faulty signal, the decoder will generate the correctly decoded signal. This ‘flushing’ of the shift register is important to the self-synchronization capacity of the descrambler.

The content of the shift register in the LFSR of FIG. 1 changes with each clock pulse. Because the LFSR will generate a maximum length binary sequence of 15 bits, the shift register will have 15 different 4-bits words. Except the word [0 0 0 0] all other 15 4-bit combinations will occur as a state of the shift-register for the sequence generator. A sequence generator is characterized by the order of 4-bit words in the shift register. Supposing that the initial state of the shift register was [0 0 1 1] the occurring 15 states are:

Shift register

| | | | |
|---|---|---|---|
| 0 | 0 | 1 | 1 |
| 0 | 0 | 0 | 1 |
| 1 | 0 | 0 | 0 |
| 0 | 1 | 0 | 0 |
| 0 | 0 | 1 | 0 |
| 1 | 0 | 0 | 1 |
| 1 | 1 | 0 | 0 |
| 0 | 1 | 1 | 0 |
| 1 | 0 | 1 | 1 |
| 0 | 1 | 0 | 1 |
| 1 | 0 | 1 | 0 |
| 1 | 1 | 0 | 1 |
| 1 | 1 | 1 | 0 |
| 1 | 1 | 1 | 1 |
| 0 | 1 | 1 | 1 |

The inventor has shown in the earlier cited patent applications that by creating 4-bits words wherein each consecutive word has the last 3 bits, or the first 3 bits in common with the previous word other sequences of 15 or 16 bits can be created. The relation between different possible orders of 4-bits words is dictated by the number of feedback taps and the function (the XOR or EQUAL function) that is used.

As also shown in the cited patent applications, it is possible to generate 16 bits sequences from 16 different words, meeting the requirement of 3 overlapping bits in consecutive 4-symbol words. Clearly these sequences cannot be generated by LFSRs because one word is always a forbidden word in an LFSR based sequence generator.

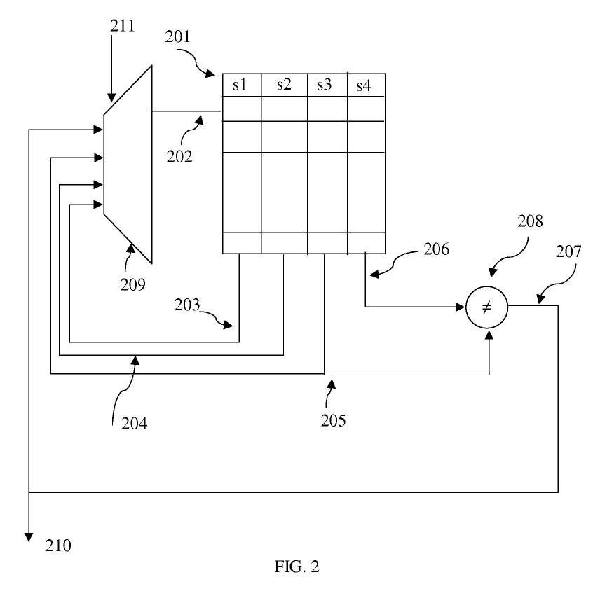

FIG. 2 shows an example of the realization of a sequence generator by means of addressable memories of a sequence generator. FIG. 2 shows the diagram of the sequence generator of FIG. 1 in memory realization. The diagram shows an addressable memory 201 which comprises all states of the shift register. Each line in the memory contains a 4-bit word which will be enabled by an active memory line 202. A memory line is made active by an address decoder 209 when a certain address is inputted into the decoder. The content of the memory lines is such that an active address enables a memory line which will represent the current state of the shift register in an LFSR based sequence generator. The last (n−1) bits of the new address are then formed by the first (n−1) bits of the content of the active memory line. The first bit of the new address is formed by combining the last two bits (205 and 206) of the current content through the XOR function 208. The first bit of the new address is provided on line 207. Output 210 for instance may then provide the binary sequence. This circuit is controlled by a clock signal 211, which controls the address decoder 209. At the occurrence of the clock signal an address is decoded and a memory line corresponding with the address is enabled.

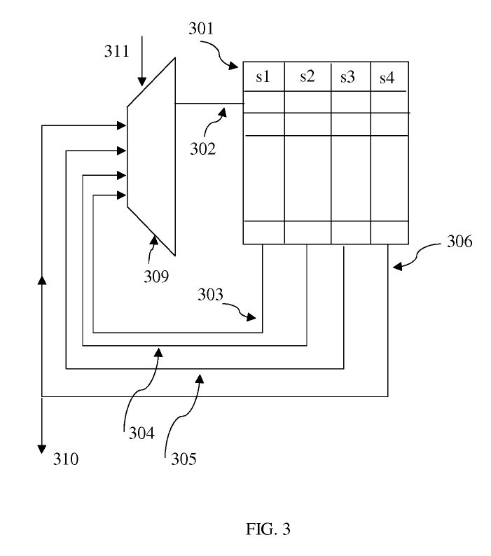

It is known that different sequences can be generated by combining different elements of the equivalent LFSR circuit. One can for instance realize the sequence generator of FIG. 2 by the circuit of which a diagram is shown in FIG. 3. The memory 301 herein contains consecutive states of the equivalent LFSR and no XOR function is now required. The next address (or state) of the generator is provided by the content of addressable memory 301. One may say that the content at a present address anticipates the new address. This content is provided to address decoder 309 and the next memory line (or generator state) is enabled by the active memory line. The address decoder is controlled by a clock signal 311. This diagram provides a method to realize sequences by way of addressable memory. As is shown in the earlier cited patent applications, standard LFSR based binary and non-binary sequences can be generated as well as sequences which cannot be realized by LFSRs, but can be realized by what is called in the cited patent applications: the “word” method.

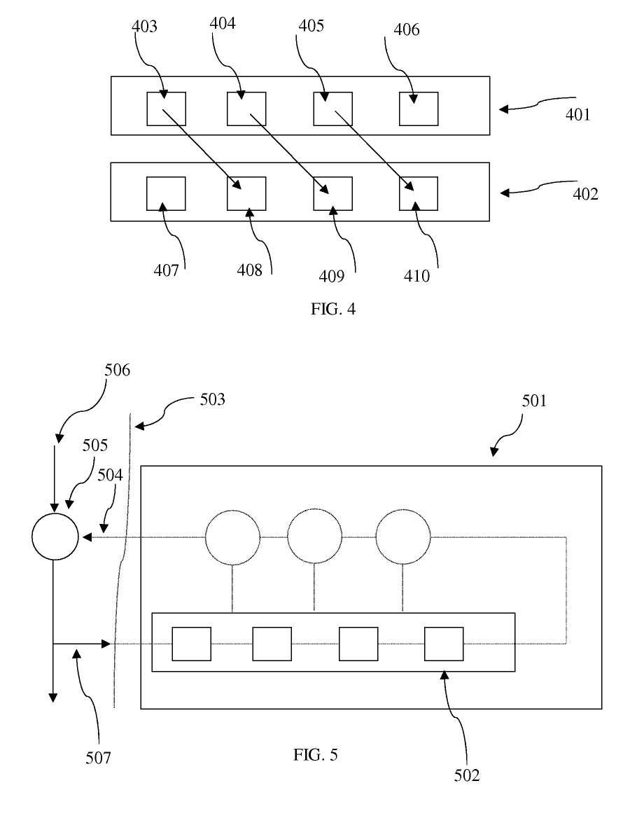

It is one aspect of the present invention to create scramblers and descramblers from memory based sequence generators. The invented method assumes a scrambler to be a sequence generator which is modified by an unknown signal through a reversible logic function. The principle works as is shown in the diagram of FIG. 4. Herein 401 represents a memory-line with 4 elements representing the address of the next state of the shift register of the sequence generator. If none of the elements 403, 404, 405 or 406 is changed then at the following clock pulse the memory line 402 (with elements 407, 408, 409 and 410) is enabled. The elements 408, 409 and 410 contain the value of 403, 404 and 405 respectively. The element 407 is separately determined and stored as part of the content at an address. The element 407 can also be determined from the previous state by the logic circuits in the feedback portion of the LFSR.

A scrambler working from the sequence generator is shown in the diagram of FIG. 5. It comprises a generator/scrambling unit 501. Signal 504 being the output of 501 can be enabled by an LFSR or from a memory based unit. That is why logic functions of 501 are drawn as dotted lines. A signal is generated by 501 and provided on 504. It should be clear that the signal on 504 is dependent on the state of the shift register 502. This state (and thus the signal on 504) can not change until a new clock signal occurs. If the signal on 504 was provided on input 507 to the shift register then the circuit of FIG. 5 would be a sequence generator. In fact the signal on 504 is identical to the content of the first element of the shift register after occurrence of a clock pulse if FIG. 5 was a sequence generator.

However FIG. 5 is a diagram of a scrambler. That means that the signal on 507 is a modified version of the signal on 504. The signal on 507 is a modification of the signal on 504 by an incoming signal on 506 by the function 505. Assume the signal on 504 to be ‘a’, the signal on 506 to be ‘x’, the signal on 507 to be ‘y’, and the function 505 to be expressed by a function ‘sc’ with a truth table. One can then create the expression: y→a sc x. When ‘sc’ is a reversible 2 input single output logic function, then ‘x’ can be recovered (or descrambled) from ‘y’ by the expression x→a ds y, wherein the logic function ‘ds’ reverses logic function ‘sc’.

It is an aspect of the present invention to create a scrambler which scrambles a binary sequence inputted on 506. A device 505 which should execute a reversible binary logic function (either XOR or EQUAL) should have the signal to be scrambled and the output of 501 as its inputs. The scrambled signal is then provided on 507.

In accordance with another aspect of the present invention, one can now create memory based binary and non-binary scramblers equivalent to p n-valued element words. The following rules describe that method:

1. create a p elements n-valued “word-based” sequence generator, wherein the last (n−1) elements of a consecutive state overlaps the first (n−1) elements of the previous state of the shift register. The overlapping elements are important for the self-synchronizing properties of the corresponding descrambler;

2. determine the first element of the next state of the sequence generator from the current state of the scrambler;

3. determine the scrambled signal by combining the to be scrambled signal with the first element of the next state of the shift register;

4. update the next state of the shift register of the scrambler by making the first element of the next state equal to the scrambled signal,

5. make the next state the current state; and

5. repeat from step 2.

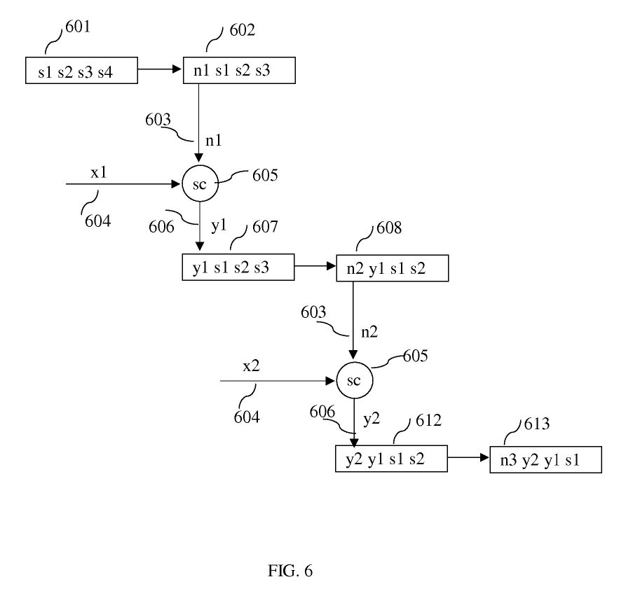

The method of scrambling n-valued symbols according to the present invention is shown in an illustrative example diagram in FIG. 6 for generating two scrambled symbols [y1 y2] from two symbols [x1 x2]. Now referring to FIG. 6. A shift register 601 of a sequence generator has content [s1 s2 s3 s4]. The next state of the generator in accordance with the “word rule” would be [n1 s1 s2 s3]. That is: all elements are moved one position to the right, the last element is lost and the first element is replaced by element n1. The state of such shift register is shown as 602. One may interpret this in terms of an addressable memory: a memory at address [s1 s2 s3 s4] has content [n1 s1 s2 s3 s4]. The first element n1 of the new state is provided on first input 603 of a function 605. A symbol x1 is provided on second input 604 of a function 605. A symbol y1 is generated on output 606 of the function ‘sc’ shown as 605. A new state 607 is then created by replacing nil with y1. In terms of a memory: a new address 607 [y1 s1 s2 s3] is formed, with content [n2 y1 s1 s2] in 608. Herein [n2 y1 s1 s2] is the state consecutive to [y1 s1 s2 s3] in the sequence generator based on a “word method”. The anticipated state n2 of the sequence generator is inputted on first input 603 of function 605 and next input symbol x2 is provided on second 604 of function ‘sc’ at 605. A symbol y2 is then outputted on output 606.

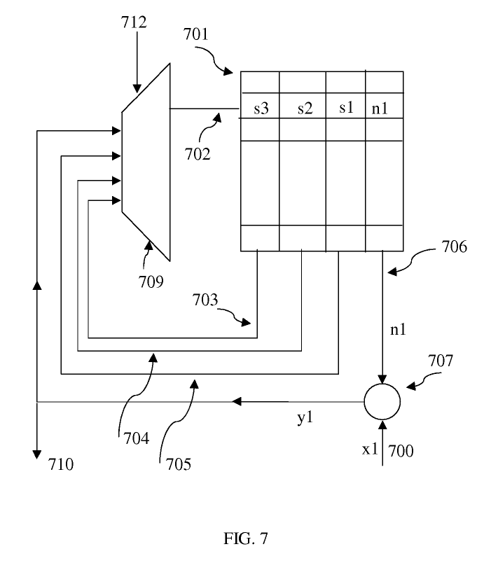

The diagram for this method as a memory based method, which is a further aspect of the present invention is shown in FIG. 7. As an illustrative example a binary scrambler equivalent with a 4-bits LFSR is used. However it should be clear that the method can be used for any n-valued logic and p-elements LFSRs and ‘word methods’. The core of the scrambler of FIG. 7 is the 4-symbol addressable memory 701 with a plurality of memory lines. For clarity of drawings the order of the elements has been reversed. Addressable memory 701 in this case comprises all possible states of an LFSR, including the forbidden state. The order of the elements in the diagram has been reversed, so that the words should be read from back to front. The first element of the shift register is now the last element s1 of the memory content. Accordingly the content of the memory appears to move from left to right. The content of each line in this binary example refers to the next stage of a 16 bits sequence generator (and NOT to a state of the scrambler). At an initial stage a memory line 702 is enabled by the address decoder 709 at a clock pulse 712. The enabled memory line comprises the next state of the sequence generator. Assume that the enabled address is [s1 s2 s3 s4]. The content of element n1 of the potential new state is combined with the to be scrambled signal x1 at 700 in a device 707. The new result y1 at 710, together with the last 3 elements [s1 s2 s3] of the new state forms the new address [y1 s1 s2 s3] of the to be enabled memory line. Enablement of the new memory line takes place at next clock pulse 712. The scrambled signal is outputted on 710.

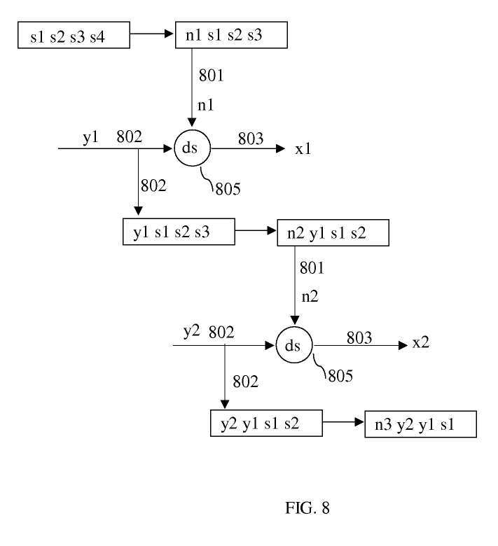

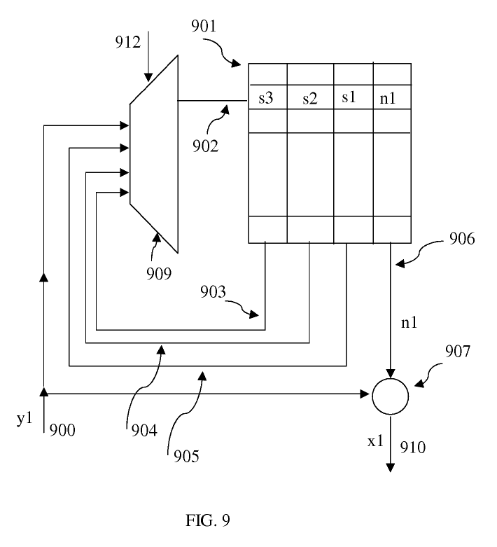

The descrambler to the above scrambler works in the same fashion. The descrambling method in accordance with another aspect of the current invention is shown in FIG. 8. Descrambling starts with the same initial state [s1 s2 s3 s4] as the corresponding scrambler. Based on this state the next state of the sequence generator [n1 s1 s2 s3] is determined by the current state. A two input single output function ‘ds’ shown as 805 is used that is the reverse from the scrambling function of the scrambler. In the binary case, if the scrambling function was the XOR function then the descrambling function is also the XOR function. The first element n1 of the next state is provided on the first input 801; the scrambled signal y1 is provided on second input 802. The output signal of ‘ds’ is provided on 803 and is then the descrambled signal of y1 and is the recovered x1. At the next clock pulse the last (n−1) elements of the new state are identical to the first (n−1) elements of the old state. The first element of the new state is the previous value of the received (and scrambled) signal y1 so that the new state is [y1 s1 s2 s3]. As with the scrambler the cycle is repeated until all scrambled symbols are descrambled.

The corresponding descrambler in memory based embodiment is shown in diagram in FIG. 9. The memory element 901 is identical to 701 with the same memory line content at similar memory addresses. A difference is how the first element of the next state is formed in the descrambler. The first element of the next state of the descrambler is always identical to the incoming (scrambled) signal provided on input 900. The signal is descrambled by inputting the (scrambled) signal on input 900 and the first element of the currently enabled memory line on input 907 of device 907 implementing the function that reverses the scrambling function. The output 910 of device 907 provides the descrambled signal. On occurrence of the clock signal 912 a next address is enabled.

It should be clear that the scrambling and descrambling methods here provided as further aspects of the present invention apply to binary and non-binary symbols. It should further be clear that symbols can be presented by electrical, optical, electro-optical, mechanical, quantum-mechanical and even atomic or molecular ways and methods. Symbols can be represented and processed in n-valued and in binary ways. The following paragraphs will provide illustrative examples of different n-valued embodiments.

In general one would prefer descrambling methods that are self-synchronizing and provide optimal randomization. For those purposes one would try to avoid ‘self-referring’ states are described (which may be considered ‘forbidden states’ for a sequence generator). For self-synchronizing purposes one would need a sequence generator that would create generator states that are ‘overlapping’ as explained in the ‘word’ method. This overlapping indicates that new elements in a state are pushed through the word from beginning to end and indicate the flushing effect. It should be clear that this overlap is not required for scrambling and descrambling per se. However if states of a sequence generator cannot be described by overlapping words, then the flushing effect will not occur at descrambling. Correct descrambling then requires exact synchronization with the corresponding scrambler.

As an illustrative example a 4-bits memory-line based scrambler/descrambler will be demonstrated. The states of the memory will be taken from the sequence generator of FIG. 1. This generator has 15 different states which are shown in the following table:

| | | |
|---|---|---|
| Shift register | Number | Followed by |

| | | | | | |
|---|---|---|---|---|---|
| 0 | 0 | 1 | 1 | 3 | 1 |
| 0 | 0 | 0 | 1 | 1 | 8 |
| 1 | 0 | 0 | 0 | 8 | 4 |
| 0 | 1 | 0 | 0 | 4 | 2 |
| 0 | 0 | 1 | 0 | 2 | 9 |
| 1 | 0 | 0 | 1 | 9 | 12 |
| 1 | 1 | 0 | 0 | 12 | 6 |
| 0 | 1 | 1 | 0 | 6 | 11 |
| 1 | 0 | 1 | 1 | 11 | 5 |
| 0 | 1 | 0 | 1 | 5 | 10 |
| 1 | 0 | 1 | 0 | 10 | 13 |
| 1 | 1 | 0 | 1 | 13 | 14 |
| 1 | 1 | 1 | 0 | 14 | 15 |
| 1 | 1 | 1 | 1 | 15 | 7 |
| 0 | 1 | 1 | 1 | 7 | 3 |

The table shows the 4-bit states as a decimal number. The last column also shows what state follows the state of the column under ‘Number’. For instance 1 follows state 3. State 3 follows state 7. Because state 0 or [0 0 0 0] is the forbidden state in the sequence generator it is assumed to ‘follow itself’. The complete addressable memory can now be created. The address of a memory line is formed by its value. The content of the memory line is the ‘followed by’ value. The following table shows the memory unit with its addresses and content in decimal and with binary values.

| Decimal | Decimal | Binary | | | | Binary | | | |
|---|---|---|---|---|---|---|---|---|---|
| Address | Content | Address | | | | Content | | | |
| 0 | 0 | 0 | 0 | 0 | 0 | 0 | 0 | 0 | 0 |
| 1 | 8 | 0 | 0 | 0 | 1 | 1 | 0 | 0 | 0 |
| 2 | 9 | 0 | 0 | 1 | 0 | 1 | 0 | 0 | 1 |
| 3 | 1 | 0 | 0 | 1 | 1 | 0 | 0 | 0 | 1 |
| 4 | 2 | 0 | 1 | 0 | 0 | 0 | 0 | 1 | 0 |
| 5 | 10 | 0 | 1 | 0 | 1 | 1 | 0 | 1 | 0 |
| 6 | 11 | 0 | 1 | 1 | 0 | 1 | 0 | 1 | 1 |
| 7 | 3 | 0 | 1 | 1 | 1 | 0 | 0 | 1 | 1 |
| 8 | 4 | 1 | 0 | 0 | 0 | 0 | 1 | 0 | 0 |
| 9 | 12 | 1 | 0 | 0 | 1 | 1 | 1 | 0 | 0 |
| 10 | 13 | 1 | 0 | 1 | 0 | 1 | 1 | 0 | 1 |
| 11 | 5 | 1 | 0 | 1 | 1 | 0 | 1 | 0 | 1 |
| 12 | 6 | 1 | 1 | 0 | 0 | 0 | 1 | 1 | 0 |
| 13 | 14 | 1 | 1 | 0 | 1 | 1 | 1 | 1 | 0 |
| 14 | 15 | 1 | 1 | 1 | 0 | 1 | 1 | 1 | 1 |
| 15 | 7 | 1 | 1 | 1 | 1 | 0 | 1 | 1 | 1 |

One can simulate a binary scrambler as in FIGS. 6 and 7 and binary descrambler as in FIGS. 8 and 9 by using the addressable memory as shown in the table in a computer program. This scrambler has the disadvantage that when the initial state is [0 0 0 0] and the incoming signal is all 0, then the scrambled signal will be all 0. However the descrambler is self synchronizing and it flushes itself from line errors or not-synchronized initial states. The following example shows an inputted signal SIG of 28 bits to the scrambler with initial state [1 0 1 0]. The scrambled signal is OUT. The scrambled signal will have line errors which makes OUT_ER having all 0s from bit 10 to 15. In the next step the signal OUT_ER is descrambled by the descrambler with initial state [1 0 1 0].

SIG=[1 1 0 0 1 0 1 1 1 0 1 1 0 0 1 1 0 0 1 0 1 1 1 0 1 1 0 0]

OUT=[0 0 1 1 1 1 1 1 1 0 1 1 1 1 1 1 0 0 1 1 1 0 1 0 0 0 1 0]

OUT_ER=[0 0 1 1 1 1 1 1 1 0 0 0 0 0 0 1 0 0 1 1 1 0 1 0 0 0 1 0]

RES=[1 1 0 0 1 0 1 1 1 0 0 0 1 0 0 1 0 0 0 0 1 1 1 0 1 1 0 0]

RES-SIG=[0 0 0 0 0 0 0 0 0 0-1-1 1 0-1 0 0 0-1 0 0 0 0 0 0 0 0 0]

The result RES-SIG is the unscrambled sequence minus the descrambled sequence, and is used to show where these two sequences differ. It should be clear that elements of SIG and RES are equal when that element of RES-SIG is 0. The result shows that the descrambled sequence differs for 4 elements from the original beyond the introduced errors. In fact the descrambler flushes itself and there is limited error propagation.

There are many 4-bits memory configurations that will create scrambling/descrambling solutions. However many of these configurations will have error propagation. They will not, or mainly by chance, recover synchronization after losing it by line errors or initial starting errors. The following table shows a 4-bits memory configuration that will be self synchronizing in scrambler/descrambler configurations as shown in FIGS. 6, 7, 8 and 9.

| Decimal | Decimal | Binary | | | | Binary | | | |
|---|---|---|---|---|---|---|---|---|---|
| Address | Content | Address | | | | Content | | | |
| 0 | 8 | 0 | 0 | 0 | 0 | 1 | 0 | 0 | 0 |
| 1 | 0 | 0 | 0 | 0 | 1 | 0 | 0 | 0 | 0 |
| 2 | 1 | 0 | 0 | 1 | 0 | 0 | 0 | 0 | 1 |
| 3 | 9 | 0 | 0 | 1 | 1 | 1 | 0 | 0 | 1 |
| 4 | 10 | 0 | 1 | 0 | 0 | 1 | 0 | 1 | 0 |
| 5 | 2 | 0 | 1 | 0 | 1 | 0 | 0 | 1 | 0 |
| 6 | 3 | 0 | 1 | 1 | 0 | 0 | 0 | 1 | 1 |
| 7 | 11 | 0 | 1 | 1 | 1 | 1 | 0 | 1 | 1 |
| 8 | 12 | 1 | 0 | 0 | 0 | 1 | 1 | 0 | 0 |
| 9 | 4 | 1 | 0 | 0 | 1 | 0 | 1 | 0 | 0 |
| 10 | 5 | 1 | 0 | 1 | 0 | 0 | 1 | 0 | 1 |
| 11 | 13 | 1 | 0 | 1 | 1 | 1 | 1 | 0 | 1 |
| 12 | 14 | 1 | 1 | 0 | 0 | 1 | 1 | 1 | 0 |
| 13 | 6 | 1 | 1 | 0 | 1 | 0 | 1 | 1 | 0 |
| 14 | 15 | 1 | 1 | 1 | 0 | 1 | 1 | 1 | 1 |
| 15 | 7 | 1 | 1 | 1 | 1 | 0 | 1 | 1 | 1 |

The scrambler/descrambler combination using this memory table is self-synchronizing as is shown in the following results, using the same input sequence and initial state [1 0 1 0] and error pattern as the previous illustrative example:

SIG=[1 1 0 0 1 0 1 1 1 0 1 1 0 0 1 1 0 0 1 0 1 1 1 0 1 0 0]

OUT=[1 1 1 0 0 1 1 0 1 1 1 0 1 1 1 0 1 1 1 1 1 1 1 0 0 0 0 1]

OUT_ER=[1 1 1 0 0 1 1 0 1 0 0 0 0 0 0 0 1 1 1 1 1 1 1 0 0 0 0 1]

RES=[1 1 0 0 1 0 1 1 1 1 1 0 0 0 1 1 1 0 0 0 0 1 1 1 0 1 1 0 0]

RES-SIG=[0 0 0 0 0 0 0 0 0 1-1-1 0 1 0 0 0 0-1 0 0 0 0 0 0 0 0 0]

Also in this case the errors are not propagated beyond the full length of the 4-bit state after the error introduction, much like in LFSR based descramblers.

Other 4-bit memory tables can also create self-synchronizing and non self-synchronizing scrambler/descrambler combinations. A combination may have an initial state that combined with a constant pattern will generate a scrambled signal sequence that is also a constant pattern, sometimes having all identical symbols.

As further illustrative examples of memory based self-synchronizing scramblers/descramblers the use of 5-bit wide memory tables will be shown. The 5-bits memory table has 32 memory lines of 5-bits. The operational principle is similar to the scrambler shown in FIGS. 6 and 7 and the descrambler shown in FIGS. 8 and 9. The scrambler starts at an initial state. This state enables an address line which enables the reading of the memory line. The first element of the enabled memory line is combined by a XOR or EQUAL function with the ‘to-be-scrambled’ signal. The scrambled output and the last 4 elements of the enabled memory line form the address of the next state. This new state is enabled when a clock pulse occurs. In the descrambler the address of the next state is formed as follows: the first element of the address of the new state is the incoming scrambled signal. The last 4 elements of the enabled memory line in the descrambler form the last 4 elements of the address of the new state. The new address is enabled on a clock-pulse. The descrambled signal is created by combining the scrambled signal with the first element of the enabled memory line by a XOR or EQUAL function, depending with which function the signal was scrambled. The following table shows the 32×5 bits memory table for a self-synchronizing scrambler/descrambler:

| Decimal | Decimal | Binary | | | | | Binary | | | | |
|---|---|---|---|---|---|---|---|---|---|---|---|
| Address | Content | Address | | | | | Content | | | | |
| 0 | 0 | 0 | 0 | 0 | 0 | 0 | 0 | 0 | 0 | 0 | 0 |
| 1 | 16 | 0 | 0 | 0 | 0 | 1 | 1 | 0 | 0 | 0 | 0 |
| 2 | 17 | 0 | 0 | 0 | 1 | 0 | 1 | 0 | 0 | 0 | 1 |
| 3 | 1 | 0 | 0 | 0 | 1 | 1 | 0 | 0 | 0 | 0 | 1 |
| 4 | 18 | 0 | 0 | 1 | 0 | 0 | 1 | 0 | 0 | 1 | 0 |
| 5 | 2 | 0 | 0 | 1 | 0 | 1 | 0 | 0 | 0 | 1 | 0 |
| 6 | 19 | 0 | 0 | 1 | 1 | 0 | 1 | 0 | 0 | 1 | 1 |
| 7 | 3 | 0 | 0 | 1 | 1 | 1 | 0 | 0 | 0 | 1 | 1 |
| 8 | 4 | 0 | 1 | 0 | 0 | 0 | 0 | 0 | 1 | 0 | 0 |
| 9 | 20 | 0 | 1 | 0 | 0 | 1 | 1 | 0 | 1 | 0 | 0 |
| 10 | 5 | 0 | 1 | 0 | 1 | 0 | 0 | 0 | 1 | 0 | 1 |
| 11 | 21 | 0 | 1 | 0 | 1 | 1 | 1 | 0 | 1 | 0 | 1 |
| 12 | 22 | 0 | 1 | 1 | 0 | 0 | 1 | 0 | 1 | 1 | 0 |
| 13 | 6 | 0 | 1 | 1 | 0 | 1 | 0 | 0 | 1 | 1 | 0 |
| 14 | 23 | 0 | 1 | 1 | 1 | 0 | 1 | 0 | 1 | 1 | 1 |
| 15 | 7 | 0 | 1 | 1 | 1 | 1 | 0 | 0 | 1 | 1 | 1 |
| 16 | 8 | 1 | 0 | 0 | 0 | 0 | 0 | 1 | 0 | 0 | 0 |
| 17 | 24 | 1 | 0 | 0 | 0 | 1 | 1 | 1 | 0 | 0 | 0 |
| 18 | 9 | 1 | 0 | 0 | 1 | 0 | 0 | 1 | 0 | 0 | 1 |
| 19 | 25 | 1 | 0 | 0 | 1 | 1 | 1 | 1 | 0 | 0 | 1 |
| 20 | 26 | 1 | 0 | 1 | 0 | 0 | 1 | 1 | 0 | 1 | 0 |
| 21 | 10 | 1 | 0 | 1 | 0 | 1 | 0 | 1 | 0 | 1 | 0 |
| 22 | 27 | 1 | 0 | 1 | 1 | 0 | 1 | 1 | 0 | 1 | 1 |
| 23 | 11 | 1 | 0 | 1 | 1 | 1 | 0 | 1 | 0 | 1 | 1 |
| 24 | 12 | 1 | 1 | 0 | 0 | 0 | 1 | 0 | 1 | 0 | 0 |
| 25 | 28 | 1 | 1 | 0 | 0 | 1 | 1 | 1 | 0 | 1 | 0 |
| 26 | 13 | 1 | 1 | 0 | 1 | 0 | 0 | 1 | 1 | 0 | 1 |
| 27 | 29 | 1 | 1 | 0 | 1 | 1 | 1 | 1 | 1 | 0 | 1 |
| 28 | 30 | 1 | 1 | 1 | 0 | 0 | 1 | 1 | 1 | 1 | 0 |
| 29 | 14 | 1 | 1 | 1 | 0 | 1 | 0 | 1 | 1 | 1 | 0 |
| 30 | 31 | 1 | 1 | 1 | 1 | 0 | 1 | 1 | 1 | 1 | 1 |
| 31 | 15 | 1 | 1 | 1 | 1 | 1 | 0 | 1 | 1 | 1 | 1 |

Using this table a 32-bit signal SIG will be scrambled using initial state [0 0 1 1 1] and using XOR as the scrambling function. The scrambled result OUT and OUT_ER with 12 errors (all 1) introduced from bit 4 to 15 in OUT are shown. The result RES shows that beyond 5-bits no error propagation occurs. This is also shown in SIG-RES.

SIG=[0 1 1 0 0 1 1 1 1 1 0 0 0 1 1 0 1 1 1 0 1 0 1 0 0 0 0 1 0 0 1 0]

OUT=[0 1 0 0 1 1 0 0 0 1 1 0 1 0 0 0 0 0 1 0 1 1 1 0 1 0 1 1 0 0 0 0]

OUT-ER=[0 1 0 1 1 1 1 1 1 0 1 0 1 1 1 1 1 0 1 0 1 1 0 0 0 0]

SIG-RES=[0 0 0-1 0 0 0 1 0 0-1-1-1 0 0 0 1 1 0-1 0 0 0 0 0 0 0 0 0 0 0 0]

The errors do not propagate beyond bit 20.

The previous scrambler/descrambler has a self-referring state at [0 0 0 0] which may be considered the consequence of a forbidden state in the related LFSR sequence generator. The following memory table avoids that self-referring state and enables a self-synchronizing scrambler/descrambler.

| Decimal | Decimal | Binary | | | | | Binary | | | | |
|---|---|---|---|---|---|---|---|---|---|---|---|
| Address | Content | Address | | | | | Content | | | | |
| 0 | 16 | 0 | 0 | 0 | 0 | 0 | 0 | 0 | 0 | 0 | 0 |
| 1 | 0 | 0 | 0 | 0 | 0 | 1 | 1 | 0 | 0 | 0 | 0 |
| 2 | 17 | 0 | 0 | 0 | 1 | 0 | 1 | 0 | 0 | 0 | 1 |
| 3 | 1 | 0 | 0 | 0 | 1 | 1 | 0 | 0 | 0 | 0 | 1 |
| 4 | 18 | 0 | 0 | 1 | 0 | 0 | 1 | 0 | 0 | 1 | 0 |
| 5 | 2 | 0 | 0 | 1 | 0 | 1 | 0 | 0 | 0 | 1 | 0 |
| 6 | 19 | 0 | 0 | 1 | 1 | 0 | 1 | 0 | 0 | 1 | 1 |
| 7 | 3 | 0 | 0 | 1 | 1 | 1 | 0 | 0 | 0 | 1 | 1 |
| 8 | 4 | 0 | 1 | 0 | 0 | 0 | 0 | 0 | 1 | 0 | 0 |
| 9 | 20 | 0 | 1 | 0 | 0 | 1 | 1 | 0 | 1 | 0 | 0 |
| 10 | 5 | 0 | 1 | 0 | 1 | 0 | 0 | 0 | 1 | 0 | 1 |
| 11 | 21 | 0 | 1 | 0 | 1 | 1 | 1 | 0 | 1 | 0 | 1 |
| 12 | 22 | 0 | 1 | 1 | 0 | 0 | 1 | 0 | 1 | 1 | 0 |
| 13 | 6 | 0 | 1 | 1 | 0 | 1 | 0 | 0 | 1 | 1 | 0 |
| 14 | 23 | 0 | 1 | 1 | 1 | 0 | 1 | 0 | 1 | 1 | 1 |
| 15 | 7 | 0 | 1 | 1 | 1 | 1 | 0 | 0 | 1 | 1 | 1 |
| 16 | 8 | 1 | 0 | 0 | 0 | 0 | 0 | 1 | 0 | 0 | 0 |
| 17 | 24 | 1 | 0 | 0 | 0 | 1 | 1 | 1 | 0 | 0 | 0 |
| 18 | 9 | 1 | 0 | 0 | 1 | 0 | 0 | 1 | 0 | 0 | 1 |
| 19 | 25 | 1 | 0 | 0 | 1 | 1 | 1 | 1 | 0 | 0 | 1 |
| 20 | 26 | 1 | 0 | 1 | 0 | 0 | 1 | 1 | 0 | 1 | 0 |
| 21 | 10 | 1 | 0 | 1 | 0 | 1 | 0 | 1 | 0 | 1 | 0 |
| 22 | 27 | 1 | 0 | 1 | 1 | 0 | 1 | 1 | 0 | 1 | 1 |
| 23 | 11 | 1 | 0 | 1 | 1 | 1 | 0 | 1 | 0 | 1 | 1 |
| 24 | 12 | 1 | 1 | 0 | 0 | 0 | 1 | 0 | 1 | 0 | 0 |
| 25 | 28 | 1 | 1 | 0 | 0 | 1 | 1 | 1 | 0 | 1 | 0 |
| 26 | 13 | 1 | 1 | 0 | 1 | 0 | 0 | 1 | 1 | 0 | 1 |
| 27 | 29 | 1 | 1 | 0 | 1 | 1 | 1 | 1 | 1 | 0 | 1 |
| 28 | 30 | 1 | 1 | 1 | 0 | 0 | 1 | 1 | 1 | 1 | 0 |
| 29 | 14 | 1 | 1 | 1 | 0 | 1 | 0 | 1 | 1 | 1 | 0 |
| 30 | 31 | 1 | 1 | 1 | 1 | 0 | 1 | 1 | 1 | 1 | 1 |
| 31 | 15 | 1 | 1 | 1 | 1 | 1 | 0 | 1 | 1 | 1 | 1 |

SIG=[0 1 1 1 0 0 1 1 1 1 1 0 0 0 1 1 0 1 1 1 0 1 0 1 0 0 0 0 1 0 0 1 0]
OUT=[0 1 0 0 1 1 0 0 0 1 1 0 1 0 0 0 0 1 1 0 0 1 0 1 1 0 0 0 0 0 0 1]
OUT-ER=[0 1 0 1 1 1 1 1 1 1 1 1 1 1 1 1 1 0 0 1 1 0 0 1 0 1 1 0 0 0 0 0 0 1]
SIG-RES=[0 0 0-1 0 0 0 1 0 0-1-1-1 0 0 0 1 0 1-1 0 0 0 0 0 0 0 0 0 0 0 0]
Using this table a 32-bit signal SIG will be scrambled using initial state [0 0 1 1 1] and XOR as the scrambling function. The scrambled result OUT and OUT_ER with 12 errors (all 1) introduced from bit 4 to 15 in OUT are shown. The result RES shows that beyond 5-bits no error propagation occurs. This is also shown in SIG-RES.

It has been shown in illustrative binary examples that memory methods can be used to realize self-synchronizing scramblers/descramblers that in fact can not be realized with simple LFSRs. The following illustrative examples show how memory methods can also be used to realize ternary (or 3-valued) self-synchronizing scramblers/descramblers.

One 27×3 ternary memory table that works as a self-synchronizing scrambler/descrambler is provided as an illustrative example in the following table.

| Decimal | Decimal | Ternary | | | Ternary | | |
|---|---|---|---|---|---|---|---|
| Address | Content | Address | | | Content | | |
| 0 | 0 | 0 | 0 | 0 | 0 | 0 | 0 |
| 1 | 18 | 0 | 0 | 1 | 2 | 0 | 0 |
| 2 | 9 | 0 | 0 | 2 | 1 | 0 | 0 |
| 3 | 10 | 0 | 1 | 0 | 1 | 0 | 1 |
| 4 | 1 | 0 | 1 | 1 | 0 | 0 | 1 |
| 5 | 19 | 0 | 1 | 2 | 2 | 0 | 1 |
| 6 | 20 | 0 | 2 | 0 | 2 | 0 | 2 |
| 7 | 11 | 0 | 2 | 1 | 1 | 0 | 2 |
| 8 | 2 | 0 | 2 | 2 | 0 | 0 | 2 |
| 9 | 3 | 1 | 0 | 0 | 0 | 1 | 0 |
| 10 | 21 | 1 | 0 | 1 | 2 | 1 | 0 |
| 11 | 12 | 1 | 0 | 2 | 1 | 1 | 0 |
| 12 | 13 | 1 | 1 | 0 | 1 | 1 | 1 |
| 13 | 4 | 1 | 1 | 1 | 0 | 1 | 1 |
| 14 | 22 | 1 | 1 | 2 | 2 | 1 | 1 |
| 15 | 23 | 1 | 2 | 0 | 2 | 1 | 2 |
| 16 | 14 | 1 | 2 | 1 | 1 | 1 | 2 |
| 17 | 5 | 1 | 2 | 2 | 0 | 1 | 2 |
| 18 | 6 | 2 | 0 | 0 | 0 | 2 | 0 |
| 19 | 24 | 2 | 0 | 1 | 2 | 2 | 0 |
| 20 | 15 | 2 | 0 | 2 | 1 | 2 | 0 |
| 21 | 16 | 2 | 1 | 0 | 1 | 2 | 1 |
| 22 | 7 | 2 | 1 | 1 | 0 | 2 | 1 |
| 23 | 25 | 2 | 1 | 2 | 2 | 2 | 1 |
| 24 | 26 | 2 | 2 | 0 | 2 | 2 | 2 |
| 25 | 17 | 2 | 2 | 1 | 1 | 2 | 2 |
| 26 | 8 | 2 | 2 | 2 | 0 | 2 | 2 |

One can create a ternary self-synchronizing scrambler/descrambler using the diagrams of FIGS. 6, 7, 8 and 9. The addressable memory units 701 and 901 are described by the above table. The scrambling device 707 in FIG. 7 and descrambling device 907 of FIG. 9 have to be reversible ternary logic functions wherein the function of 907 reverses the function of 707. One simple solution is wherein the function is self-reversing, so 707 is identical to 907. As an illustrative example it is assumed that the self-reversing ternary function ‘ter’ is used. The following table shows the truth table of ‘ter’.

| ter | 0 | 1 | 2 |
|---|---|---|---|
| 0 | 2 | 1 | 0 |
| 1 | 1 | 0 | 2 |
| 2 | 0 | 2 | 1 |

A ternary signal SIG is scrambled with the ternary scrambler, with initial state [2 0 1]. The scrambled signal is OUT. A series of errors of 2s from symbol 4 to 15 is introduced into the scrambled signal and is shown as OUT_ER. This signal is descrambled by the descrambler with initial state [2 0 1] and its result is shown as RES. Also shown is the difference RES-SIG.

SIG=[1 1 0 0 2 0 2 1 2 2 1 0 2 2 2 0 0 1 0 1 2 1 1 2 0 1 1]

OUT=[2 2 2 2 0 2 2 2 0 0 0 2 0 1 2 1 1 2 2 0 0 0 1 0 1 2 0]

OUT_ER=[2 2 2 2 2 2 2 2 2 2 2 2 2 2 2 1 1 2 2 0 0 0 1 0 1 2 0]

RES=[1 1 0 0 0 0 0 0 0 0 0 0 0 0 0 1 1 1 0 1 2 1 1 2 0 1 1]

RES-SIG=[0 0 0 0-2 0-2-1-2-2-1 0-2-2-2 1 1 0 0 0 0 0 0 0 0 0 0]

This is an example how the errors do not propagate beyond the length of one complete 3 symbol word.

The above scrambler/descrambler has a self-referring state at [0 0 0]. One can create a different ternary scrambler by using the following table:

| Decimal | Decimal | Ternary | | | Ternary | | |
|---|---|---|---|---|---|---|---|
| Address | Content | Address | | | Content | | |
| 0 | 18 | 0 | 0 | 0 | 2 | 0 | 0 |
| 1 | 0 | 0 | 0 | 1 | 0 | 0 | 0 |
| 2 | 9 | 0 | 0 | 2 | 1 | 0 | 0 |
| 3 | 10 | 0 | 1 | 0 | 1 | 0 | 1 |
| 4 | 1 | 0 | 1 | 1 | 0 | 0 | 1 |
| 5 | 19 | 0 | 1 | 2 | 2 | 0 | 1 |
| 6 | 20 | 0 | 2 | 0 | 2 | 0 | 2 |
| 7 | 11 | 0 | 2 | 1 | 1 | 0 | 2 |
| 8 | 2 | 0 | 2 | 2 | 0 | 0 | 2 |
| 9 | 3 | 1 | 0 | 0 | 0 | 1 | 0 |
| 10 | 21 | 1 | 0 | 1 | 2 | 1 | 0 |
| 11 | 12 | 1 | 0 | 2 | 1 | 1 | 0 |
| 12 | 13 | 1 | 1 | 0 | 1 | 1 | 1 |
| 13 | 4 | 1 | 1 | 1 | 0 | 1 | 1 |
| 14 | 22 | 1 | 1 | 2 | 2 | 1 | 1 |
| 15 | 23 | 1 | 2 | 0 | 2 | 1 | 2 |
| 16 | 14 | 1 | 2 | 1 | 1 | 1 | 2 |
| 17 | 5 | 1 | 2 | 2 | 0 | 1 | 2 |
| 18 | 6 | 2 | 0 | 0 | 0 | 2 | 0 |
| 19 | 24 | 2 | 0 | 1 | 2 | 2 | 0 |
| 20 | 15 | 2 | 0 | 2 | 1 | 2 | 0 |
| 21 | 16 | 2 | 1 | 0 | 1 | 2 | 1 |
| 22 | 7 | 2 | 1 | 1 | 0 | 2 | 1 |
| 23 | 25 | 2 | 1 | 2 | 2 | 2 | 1 |
| 24 | 26 | 2 | 2 | 0 | 2 | 2 | 2 |
| 25 | 17 | 2 | 2 | 1 | 1 | 2 | 2 |
| 26 | 8 | 2 | 2 | 2 | 0 | 2 | 2 |

Again as an illustrative example ternary signal SIG is scrambled with the ternary scrambler, with initial state [2 0 1] but using the new table. The scrambled signal is OUT. A series of errors of 2s from symbol 4 to 15 is introduced into the scrambled signal and is shown as OUT_ER. This signal is descrambled by the descrambler with initial state [2 0 1] and its result is shown as RES. Also shown is the difference RES-SIG.

SIG=[1 1 0 0 2 0 2 1 2 2 1 0 2 2 2 0 0 1 0 1 2 1 1 2 0 1 1]

OUT=[2 2 2 2 0 2 2 2 0 0 0 0 1 0 2 0 0 0 0 2 0 2 0 1 1 0 1]

OUT-ER=[2 2 2 2 2 2 2 2 2 2 2 2 2 2 2 0 0 0 0 2 0 2 0 1 1 0 1]

RES=[1 2 2 0 0 0 0 0 0 0 0 0 0 0 0 2 2 1 0 1 2 1 1 2 0 1 1]

RES-SIG=[0 1 2 0-2 0-2-1-2-2-1 0-2-2-2 2 2 0 0 0 0 0 0 0 0 0 0]

No major error propagation takes place. The here shown scrambler/descrambler can not or not easily be formed by LFSRs. More self-synchronizing 3-symbol and p-symbol (with p an integer greater than 3) ternary and n-valued scramblers/descramblers can be created in accordance with the here described methods of the present invention. Different tables as well as different scrambling and descrambling functions can be used.

The methods for creating scramblers/descramblers can be used for any n-valued logic. Why these methods are self-synchronizing for the descramblers becomes apparent when one re-arranges the states in the addressable memory in their consecutive order. It becomes clear that previous state of the scrambled signal is becoming the next element in the next state. Consequently the scrambled signal is ‘pushed’ through the consecutive states or elements of the memory-line. When a memory-line contains p elements, an error will be ‘flushed’ after p potentially wrongly descrambled elements. It should be clear that there are different n-valued, p elements memory based self-synchronizing scramblers/descramblers, of which several cannot be easily (without extra circuitry) realized with LFSR methods.

The following illustrative example shows the table for a 4-valued, 2-elements memory based scrambler/descrambler.

| | | | |
|---|---|---|---|
| 4-valued | decimal | | |
| consecutive | consecutive | 4-valued | 4-valued |
| states | states | address | content |

| | | | | | | |
|---|---|---|---|---|---|---|
| 0 | 0 | 0 | 0 | 0 | 1 | 0 |
| 1 | 0 | 4 | 0 | 1 | 2 | 0 |
| 0 | 1 | 1 | 0 | 2 | 3 | 0 |
| 2 | 0 | 8 | 0 | 3 | 0 | 0 |
| 2 | 2 | 10 | 1 | 0 | 0 | 1 |
| 3 | 2 | 14 | 1 | 1 | 2 | 1 |
| 3 | 3 | 15 | 1 | 2 | 1 | 1 |
| 2 | 3 | 11 | 1 | 3 | 3 | 1 |
| 1 | 2 | 6 | 2 | 0 | 2 | 2 |
| 1 | 1 | 5 | 2 | 1 | 0 | 2 |
| 2 | 1 | 9 | 2 | 2 | 3 | 2 |
| 0 | 2 | 2 | 2 | 3 | 1 | 2 |
| 3 | 0 | 12 | 3 | 0 | 1 | 3 |
| 1 | 3 | 7 | 3 | 1 | 0 | 3 |
| 3 | 1 | 13 | 3 | 2 | 3 | 3 |
| 0 | 3 | 3 | 3 | 3 | 2 | 3 |

The table can be used in a 4-valued scrambler/descrambler as explained in FIGS. 6, 7, 8 and 9 with the 16×2 memory 701 and 901 being represented by the above table. As the scrambling function 707 in FIG. 7 the self-reversing 4-valued logic function ‘quat’ is used. The truth table of ‘quat’ is show in the following truth table.

| quat | 0 | 1 | 2 | 3 |
|---|---|---|---|---|
| 0 | 3 | 2 | 1 | 0 |
| 1 | 2 | 1 | 0 | 3 |
| 2 | 1 | 0 | 3 | 2 |
| 3 | 0 | 3 | 2 | 1 |

SIG=[0 0 1 0 2 2 3 2 1 1 2 0 3 1 3 3]

OUT=[1 2 2 0 2 3 1 2 2 3 2 2 1 1 2 0]

OUT_ER=[1 2 1 1 1 1 1 2 2 3 2 2 1 1 2 0]

RES=[0 0 2 1 0 0 0 3 1 1 2 0 3 1 3 3]

RES-SIG=[0 0 1 1-2-2-3 1 0 0 0 0 0 0 0 0]

Like in previous examples errors are introduced in the scrambled signal. This illustrative example shows that the error does not propagate beyond the length of the size of the memory-line (in this case 2 elements). Exhaustive tests with different signals and different errors will further prove the self-synchronizing aspects and the limited error propagation.

The n-valued memory or n-valued memory tables of the illustrative binary and n-valued examples are generally expressing maximum length or close to maximal length sequence generators. This will also provide close to optimally performing scramblers. In a practical sense one could use smaller tables of words of m n-valued symbols. The maximum size of a table of words of m n-valued symbols is of n^{m} memory lines. One may want to use smaller tables in scramblers and descramblers, using not all possible words. The only practical caveat for using smaller tables is that errors in a received scrambled sequence may create non-valid addresses for the descrambler. Accordingly a facility has to be included in the descrambler that will catch non-valid addresses during descrambling.

As memory one may use different technologies: DRAM, SRAM, Look-up Table, EPROM, or storage media like magnetic or optical disks. These examples are not limiting and include any addressable storage facility. The requirement is that each state or word of a scrambler/descrambler in memory has an address that can be enabled.

It is also contemplated that scramblers/descramblers can be executed by processors with local memory or with separate memory. The processors can even be programmed to execute different scramblers/descramblers by providing new memory tables and/or n-valued reversible functions.

Memory tables can be quite large. Especially with non-volatile memory media it is necessary to load or initiate the memory table. One can do this at start-up from storage, or one may use an LFSR to generate the states at a convenient clock rate during initiating, and for instance switch to a different clock rate at and lower energy consumption during operation.

Another aspect of the present invention is to change the n-valued reversible logic function between scrambling and descrambling steps. FIG. 6 shows two steps of the scrambling method, wherein in both steps a function sc in 605 is used. It is possible to change this function such that in the binary case sc is sometimes the XOR function and at other times the equal function. For correct descrambling one should have the matching descrambling function ds in 805 available. In the n-valued case for instance for n=4, there are many more reversible functions. One should take care of applying the correct matching descrambling function ds in 805 in the descrambler. Careful synchronization of the functions is required.

One can achieve the dynamic assignment of different functions in different ways. For instance in one embodiment one can achieve this by including a code for a specific n-valued function in a memory line associated with an address. This code may then enable a function in e separate device. Another way would be to include the complete truth table as part of an extended memory line. That means that all scrambler and descrambler information is then included in a memory table. One can still use the same memory table for scramblers and descramblers. However in case of a descrambler means should be included to determine from the available truth table the truth table of the reversing function.

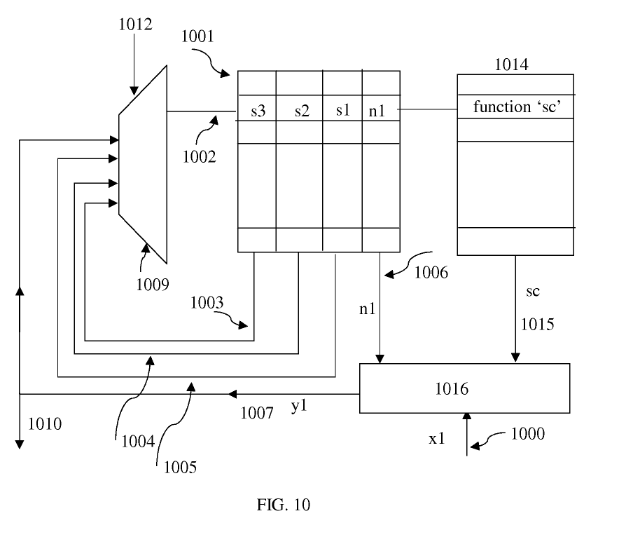

FIG. 10 shows a diagram of one illustrative embodiment of a scrambler with dynamic function assignment. The structure is almost identical to the embodiment as shown in FIG. 7. However in FIG. 10 the function sc is replaced by a device 1016 that implements an n-valued function sc. The inputs to the device are n1 through input 1006, representing a symbol of the next state of the applied sequence generator, x1 or a symbol of the sequence to be scrambled on input 1000. In addition there is an input 1015 coming from the extended addressable memory 1014 that is also controlled like memory 1001 by the address decoder 1009 and clock signal 1012. An enabled memory line in 1014 may provide the complete truth table to the device 1016; it may also provide a code for device 1016 that allows 1016 to retrieve the related truth table. The inputs x1 and n1 then provide the input coordinates to the activated truth table and the resulting symbol is outputted on 1007 and on 1010. One may provide just one truth table in all memory lines of 1014, whereby the scrambler of FIG. 10 is equivalent to FIG. 7.

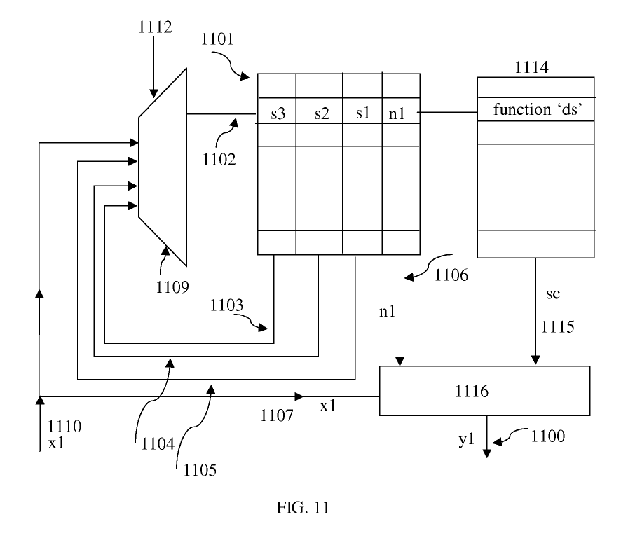

The same type of embodiment may be applied to the descrambler which is shown in FIG. 11. In this case it is similar to the descrambler of FIG. 9. Like with the scrambler the function is now embedded in an extension 1114 of memory 1101 controlled by an address decoder 1109 and a clock signal 1112. The code of an enabled memory line represents an n-valued functions ‘ds’, which should reverse a function ‘sc’ in a corresponding position in the corresponding scrambler. The device 1116 has the same function as device 1016 of the scrambler of FIG. 10. However the descrambler structure is different from the scrambler: input 1106 provides a symbol of a relevant state of the related sequence generator; input 1115 provides the data of the enabled function ‘ds’; 1107 is an input to the device 1116 providing a symbol x1 of a sequence of symbols to be descrambled, which is inputted on 1110; a descrambled symbol y1 is outputted by the device 1116 on output 1100.

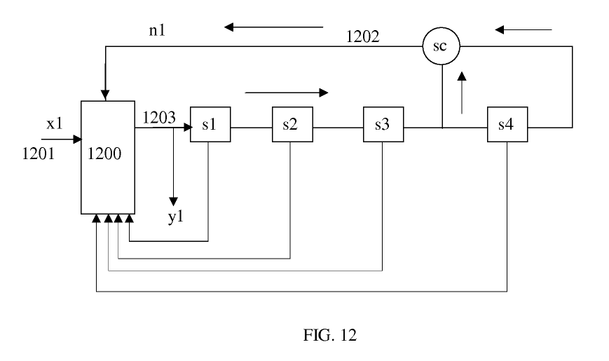

It should be clear to those skilled in the art that one can apply the dynamic changing of function, depending on the state of a memory, also to the shift register based embodiment of n-valued scramblers and descramblers. In that case one would replace a function by a device that implements such a function. Which function is implemented depends on the state of the shift register and the feedback symbol. FIG. 12 shows a diagram of one embodiment of an LFSR with a dynamically changing function. This function is implemented by device 1200. What function it implements depends on the state [s1 s2 s3 s4] of the shift register, which may be called a lagging function; it may also depend on the shift register state [s1 s2 s3 s4] and the feedback state nil, which may be called a leading function. The diagram of FIG. 12 provides a scrambler of a symbol x1 which results in a symbol y1. Symbol y1 is created by device 1200 executing an n-valued logic function on x1 and n1. For those skilled in the art it is easy to see how the embodiment of FIG. 12 can be adapted to become a descrambler.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

The following patent applications, including the specifications, claims and drawings, are hereby incorporated by reference herein, as if they were fully set forth herein: (1) U.S. Non-Provisional patent application Ser. No. 10/935,960, filed on Sep. 8, 2004, entitled TERNARY AND MULTI-VALUE DIGITAL SCRAMBLERS, DESCRAMBLERS AND SEQUENCE GENERATORS; (2) U.S. Non-Provisional patent application Ser. No. 10/936,181, filed Sep. 8, 2004, entitled TERNARY AND HIGHER MULTI-VALUE SCRAMBLERS/DESCRAMBLERS; (3) U.S. Non-Provisional patent application Ser. No. 10/912,954, filed Aug. 6, 2004, entitled TERNARY AND HIGHER MULTI-VALUE SCRAMBLERS/DESCRAMBLERS; (4) U.S. Non-Provisional patent application Ser. No. 11/042,645, filed Jan. 25, 2005, entitled MULTI-VALUED SCRAMBLING AND DESCRAMBLING OF DIGITAL DATA ON OPTICAL DISKS AND OTHER STORAGE MEDIA; (5) U.S. Non-Provisional patent application Ser. No. 11/000,218, filed Nov. 30, 2004, entitled SINGLE AND COMPOSITE BINARY AND MULTI-VALUED LOGIC FUNCTIONS FROM GATES AND INVERTERS; (6) U.S. Non-Provisional patent application Ser. No. 11/065,836 filed Feb. 25, 2005, entitled GENERATION AND DETECTION OF NON-BINARY DIGITAL SEQUENCES; (7) U.S. Non-Provisional patent application Ser. No. 11/139,835 filed May 27, 2005, entitled MULTI-VALUED DIGITAL INFORMATION RETAINING ELEMENTS AND MEMORY DEVICES; (8) U.S. Non-Provisional patent application Ser. No. 11/427,498 filed on Jun. 29, 2006 entitled CREATION AND DETECTION OF BINARY AND NON_BINARY PSEUDO-NOISE SEQUENCES NOT USING LFSR CIRCUITS; (9) U.S. Non-Provisional patent application Ser. No. 11/534,777 filed on Sep. 25, 2006 entitled: ENCIPHERMENT OF DIGITAL SEQUENCES BY REVERSIBLE TRANSPOSITION METHODS; (10) U.S. Non-Provisional patent application Ser. No. 11/534,837 filed on Sep. 25, 2006 entitled: GENERATION AND SELF-SYNCHRONIZING DETECTION OF SEQUENCES USING ADDRESSABLE MEMORIES.

What is claimed:

1. A method of generating a scrambled sequence from an input sequence using a plurality of addresses, each of the plurality of addresses being associated with a multi-symbol word, comprising:
selecting one of the plurality of addresses; and
processing a symbol from a first multi-symbol word associated with the selected address and a symbol from the input sequence with a function to generate a next symbol for the scrambled sequence.

2. The method of claim 1, wherein the function is an n-valued reversible logic function. and an address and a multi-symbol word both have m n-valued symbols with m≧2.

3. The method of claim 1, further comprising:
using the next symbol to generate another one of the plurality of addresses; and
processing a symbol from another multi-symbol word that is associated with the generated address and another symbol from the input sequence with the function to generate a new next symbol.

4. The method of claim 3, wherein the symbol of the first multi-symbol word and the symbol of the another multi-symbol word are a first symbol in the multi-symbol words.

5. The method of claim 3, comprising repeating the steps of claim 3 until the input sequence is completely scrambled.

6. The method of claim 2, wherein an address and an associated multi-symbol word have (m−1) consecutive symbols in common.

7. The method as claimed in claim 2, wherein no address is identical to an associated multi-symbol word.

8. The method as claimed in claim 2, wherein there are n^{m} different addresses.

9. A method of generating a descrambled sequence from an input sequence using a plurality of addresses, each of the plurality of addresses being associated with a multi-symbol word, comprising:
selecting one of the plurality of addresses; and
processing a symbol from a first multi-symbol word associated with the selected address and a symbol from the input sequence with a function to generate a next symbol for the descrambled sequence.

10. The method of claim 9, wherein the function is an n-valued reversible logic function. and an address and a multi-symbol word both have m n-valued symbols with m≧2.

11. The method of claim 9, further comprising:
using the symbol from the input sequence to generate another one of the plurality of addresses; and
processing a symbol from another multi-symbol word that is associated with the generated address and another symbol from the input sequence with the function to generate a new next symbol.

12. The method of claim 11, wherein the symbol of the first multi-symbol word and the symbol of the another multi-symbol word are a first symbol in the multi-symbol words.

13. The method of claim 11, comprising repeating the steps of claim 11 until the input sequence is completely scrambled.

14. The method of claim 10, wherein an address and an associated multi-symbol word have (m−1) consecutive symbols in common.

15. The method as claimed in claim 10, wherein no address is identical to an associated multi-symbol word.

16. The method as claimed in claim 10, wherein there are n^{m} different addresses.

17. An apparatus for scrambling a sequence of n-valued symbols, comprising:
an addressable memory having a plurality of memory lines and an address decoder, wherein:
each memory line has an address with an associated word of m n-valued symbols; and
a memory line can be enabled by the address decoder to make the m n-valued symbols of the associated word available on m memory outputs;
the address decoder having m inputs, forming an address of a memory line;
an n-valued device, having a first and a second input and an output, implementing a reversible n-valued logic function;
a first of the m memory outputs being connected with the first input of the n-valued device;
the second input of the n-valued device being configured to receive a symbol from the sequence;
the m−1 memory outputs, not including the first of the m memory outputs, being connected to m−1 inputs of the address decoder;
the output of the n-valued device being connected to the one of m address decoder inputs not directly connected to a memory output; and wherein
a scrambled symbol can be provided on the output of the n-valued device.

18. The apparatus as claimed in claim 17, wherein the plurality of words is n^{m}.

19. An apparatus for descrambling a sequence of n-valued symbols, comprising:
an addressable memory having a plurality of memory lines and an address decoder, wherein:
each memory line has an address with an associated word of m n-valued symbols; and
a memory line can be enabled by the address decoder to make the m n-valued symbols of the associated word available on m memory outputs;
the address decoder having m inputs, forming an address of a memory line;
an n-valued device, having a first and a second input and an output, implementing a reversible n-valued logic function;
a first of the m memory outputs being connected with the first input of the n-valued device;
the second input of the n-valued device being configured to receive a symbol from the sequence;
the m−1 memory outputs, not including the first of the m memory outputs, being connected to m−1 inputs of the address decoder;
the one of m address decoder inputs not directly connected to a memory output being configured to receive a symbol from the sequence; and
the output of the n-valued device being configured to provide a descrambled symbol.

20. The apparatus as claimed in claim 19, wherein the plurality of words is n^{m}.
